(19) United States
(12) Patent Application Publication
(10) Pub. No.: US 2010/0225027 A1
(43) Pub. Date: Sep. 9, 2010

(54) OPTICAL PROCESSING METHOD AND MASK

(75) Inventors: Tomohide Jozaki, Kanagawa (JP); Shunsuke Matsui, Kanagawa (JP); Shingo Nanase, Kanagawa (JP); Hidehisa Murase, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/711,362

(22) Filed: Feb. 24, 2010

(30) Foreign Application Priority Data
Mar. 6, 2009 (JP) 2009-053083

(51) Int. Cl. B29C 35/08; G21K 1/00

(52) U.S. Cl. 264/400; 250/505.1

(57) ABSTRACT

An optical processing method includes the steps of: moving an irradiation region of light in a direction orthogonal to a width direction of a mask having openings aligned in the width direction while irradiating the light to a processing object via the mask; and when irradiating light across one width of the mask and moving the irradiation region in a latter stage after irradiation of light across one width of the mask and movement of the irradiation region in a former stage end, superimposing a part of a light irradiation portion by the irradiation of light across one width of the mask and the movement in the former stage and a part of a light irradiation portion by the irradiation of light across one width of the mask and the movement in the latter stage to make an irradiation amount equal in each irradiation line corresponding to the respective openings.

### BACKGROUND OF THE INVENTION

1. Field of the Invention

The present invention relates to an optical processing method and a mask, and more particularly, to an optical processing method of forming a 3D shape in a processing object with energy of irradiated light by moving an irradiation region while irradiating light onto the processing object via a mask and a mask.

2. Description of the Related Art

As a method of processing a 3D shape using energy of light, there is a method of directly molding a shape of a processing object without using photolithography. Examples of such a processing method include a laser processing method using an excimer laser as is disclosed, for example, in JP-A-2004-160518. More specifically, an excimer laser has photon energy high enough to cut a chemical bonding and is therefore capable of removing a material from a processing object by a photochemical reaction called ablation while suppressing thermal influences.

Such laser processing by ablation makes ablation processing applicable to various materials, such as plastic, metal, and ceramics, by irradiating an excimer laser beam at adjusted energy density. Because this processing is to trim a processing shape into a desired shape, it is necessary to design and manufacture a mask that limits a laser beam irradiation region.

### SUMMARY OF THE INVENTION

However, there is a limit with an irradiation area by an excimer laser. Hence, in order to obtain a desired processing shape on a large-area substrate, it is necessary to join laser beam irradiation regions via a mask in a plurality of stages. When laser beam irradiation regions via a mask are joined in this manner, an abnormal shape develops at the seam.

Thus, it is desirable to suppress the development of an abnormal shape at a seam portion of the light irradiation regions via a mask during 3D shape processing performed by irradiating light via a mask.

According to an embodiment of the present invention, there is provided an optical processing method including the steps of: moving an irradiation region of light in a direction orthogonal to a width direction of a mask having a plurality of openings aligned in the width direction while irradiating the light to a processing object via the mask; and when irradiating light across one width of the mask and moving the irradiation region in a latter stage after irradiation of light across one width of the mask and movement of the irradiation region, superimposing a part of a light irradiation portion by the irradiation of light across one width of the mask and the movement of the irradiation region in the former stage and a part of a light irradiation portion by the irradiation of light across one width of the mask and the movement of the irradiation region in the latter stage to make an irradiation amount of light equal in each of irradiation lines corresponding to the respective openings.

Owing to the configuration according to an embodiment of the present invention, because an irradiation amount of light in a seam portion of the irradiation regions of light via the mask becomes equal to an irradiation amount of light in portions other than the seam portion, it becomes possible to obtain a seamless smooth processing shape.

The term, “openings in the mask”, referred to herein means a portion transmitting light and includes a light-transmitting window in addition to an opening hole. Also, the term, “irradiation lines”, referred to herein means irradiation regions formed on the processing object in a linear shape by moving the irradiation region of light passing through the respective openings.

In order to perform irradiation of light as above, it may be configured in such a manner that a plurality of the openings in line along the width direction of the mask are provided in a plurality of lines in the direction orthogonal to the width direction and the number of the plurality of the openings corresponding to the parts to be superimposed may varies line by line.

Also, it may be configured in such a manner that the number of the plurality of the openings corresponding to the parts to be superimposed gradually varies line by line or the number of the plurality of the openings corresponding to the parts to be superimposed varies in a part of the lines.

Also, it may be configured in such a manner that the movement of the irradiation region of light is performed in mutually orthogonal two directions on the processing object, so that it becomes possible to form a plurality of 3D shapes (for example, lens shapes) in a matrix fashion.

Also, it may be configured in such a manner that a first mask and a second mask having different shapes and a same pitch of the plurality of openings are used as the mask and the irradiation of light and the movement of the irradiation region are performed at a same position on the processing object using the first mask and the second mask.

For example, when a shape of a rim of each opening in the first mask is formed of a curve and a shape of a rim of each opening in the second mask is formed of a straight line, a variety of irradiation amounts of light can be achieved by superimposing irradiation of light using these masks. It thus becomes possible to form a complex 3D shape.

According to another embodiment of the present invention, there is provided a mask including: an opening forming region in which a plurality of openings are aligned vertically and horizontally; a region including a diagonal line at a predetermined angle with respect to a central axis of the opening forming region in a horizontal direction in a predetermined region on one side of the central axis; and another region including a diagonal line at a same angle as the predetermined angle with respect to the central axis in a predetermined region on the other side of the central axis.

Further, according to still another embodiment of the present invention, there is provided a mask including: an opening forming region in which a plurality of openings are aligned vertically and horizontally; a first region including a diagonal line at a predetermined angle with respect to a central axis of the opening forming region in a horizontal direction in a predetermined region on one side of the central axis; and a second region line symmetric to the first region with respect to the central axis in a predetermined region on the other side of the central axis.

Owing to these configurations according to embodiments of the present invention, light irradiation portions in both the regions including the diagonal lines on one side and on the other side of the central axis are superimposed in a seam portion of the irradiation regions of light via the mask and an irradiation amount of light in the seam portion becomes equal to an irradiation amount of light in portions other then the seam portion. It thus becomes possible to obtain a seamless smooth processing shape.

According to the embodiments of the present invention, there can be achieved the following advantages. That is, by forming a shape in a processing object by performing irradiation of light via the mask and scanning of the irradiation region, it becomes possible to form the seam portion of the irradiation regions and portions other than the seam portion in the same shape.

### BRIEF DESCRIPTION OF THE DRAWINGS

FIG. 1 is a view used to describe the configuration of a laser processing device to which an optical processing method according to an embodiment of the present invention is applied;

FIG. 2 is a view used to describe the processing principle of the OG method;

FIG. 3 is a schematic perspective view used to describe a relative position of a mask and a substrate as a processing object;

FIG. 4 is a view used to describe a comparative example of the processing by the OG method;

FIG. 5A and FIG. 5B are views showing the surface shape in a seam portion of irradiation regions shown in FIG. 4 and a measurement result, respectively;

FIG. 6A and FIG. 6B are views showing the surface shape and a measurement result, respectively, in a case where a processing shape at the seam of the irradiation regions is a trough shape;

FIG. 7 is a view used to describe a mask used in the optical processing method according to the embodiment of the present invention;

FIG. 8 is a schematic view used to describe superimposition of the irradiation regions and an irradiation amount;

FIG. 9A through FIG. 9C are schematic views used to describe the optical processing method (first half) according to the embodiment of the present invention;

FIG. 10A through FIG. 10C are schematic views used to describe the optical processing method (second half) according to the embodiment of the present invention;

FIG. 11 is a plan view used to describe another example of the mask configuration (Example 1) according to an embodiment of the present invention;

FIG. 12 is a plan view used to describe still another example of the mask configuration (Example 2) according to an embodiment of the present invention;

FIG. 13 is a plan view used to describe still another example of the mask configuration (Example 3) according to an embodiment of the present invention;

FIG. 14 is a plan view used to describe still another example of the mask configuration (Example 4) according to an embodiment of the present invention;

FIG. 15 is a plan view used to describe still another example of the mask configuration (Example 5) according to an embodiment of the present invention;

FIG. 16 is a plan view used to describe still another example of the mask configuration (Example 6) according to an embodiment of the present invention;

FIG. 17 is a schematic perspective view used to describe another example of a laser processing device to which the optical processing method according to an embodiment of the present invention is applied;

FIG. 18 is a view used to describe a multidimensional polynomial curve to form a 3D shape;

FIG. 19 is a schematic view used to describe an etching sectional area to obtain a desired convex shape;

FIG. 20 is a schematic view used to describe a mask shape to obtain a desired convex shape;

FIG. 21 is a schematic view used to describe an etching sectional area to obtain a desired concave shape;

FIG. 22 is a schematic view used to describe a mask shape to obtain a desired concave shape;

FIG. 23 is a view showing a relation between irradiation energy of a laser beam and an etching depth;

FIG. 24 is a view showing a relation between a table feeding rate and an etching depth;

FIG. 25A and FIG. 25B are schematic views used to describe an aspect ratio of a mask;

FIG. 26 is a schematic view used to describe an etching sectional area in a first example of the mask configuration;

FIG. 27 is a schematic view used to describe the first example of the mask configuration;

FIG. 28 is a schematic view used to describe superimposition in the first example of the mask configuration;

FIG. 29A and FIG. 29B are schematic views used to describe a mask having an elliptical arc in a second example of the mask configuration;

FIG. 30A and FIG. 30B are schematic views used to describe a mask having a straight line in the second example of the mask configuration; and

FIG. 31A and FIG. 31B are views used to describe irradiation using superimposition of the mask having an elliptical arc and the mask having a straight line.

### DESCRIPTION OF THE PREFERRED EMBODIMENTS

Hereinafter, embodiments of the present invention will be described in the following order.

1. Configuration of laser processing device (device configuration and configurations of respective portions)

2. Processing principle of the OG method (processing principle view of the OG method and processing method using the OG method)

3. Comparative example (mask configuration and joining and surface shape of joined portion)

4. Mask according to embodiment of the present invention (mask configuration, first region, and second region)

5. Optical processing method according to embodiment of the present invention

6. Other examples of the mask configuration according to embodiment of the present invention (Examples 1 through 6 of the configuration)

7. Example of another laser processing device (device configuration and processing method)

8. Mask configuration (fundamental idea, first example of the mask configuration, and second example of the mask configuration)

9. Applicable field.

### 1. Configuration of Laser Processing Device

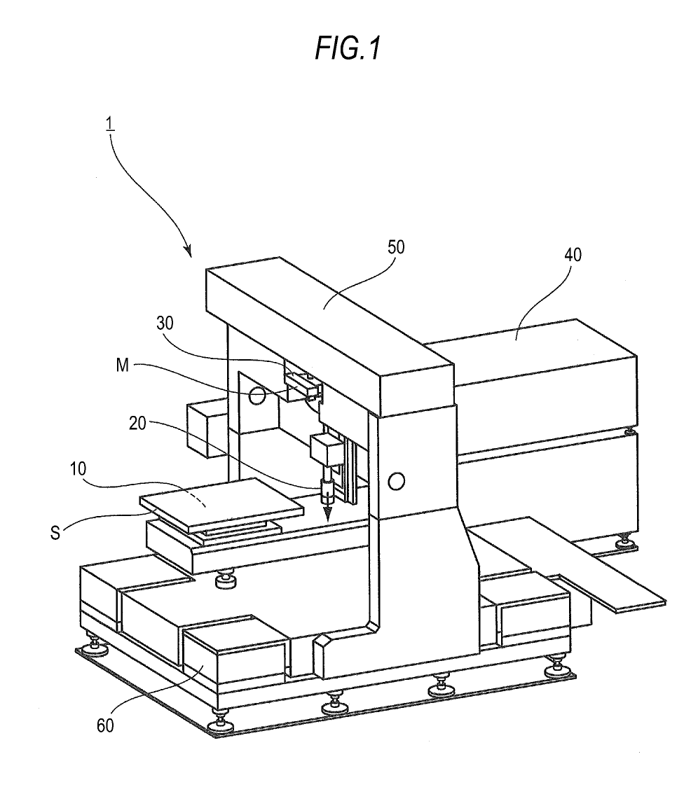

FIG. 1 is a view used to describe the configuration of a laser processing device to which an optical processing method according to an embodiment of the present invention is applied. The optical processing method according to the embodiment of the present invention is to form a desired 3D shape in a processing object using energy of light. A laser beam, particularly, an excimer laser beam is used as the light. However, visible light other than a laser beam and incoherent light, such as an UV ray, are also available. Herein, a case where an excimer laser beam is used will be described.

### Device Configuration

As is shown in FIG. 1, a laser processing device 1 includes a substrate attraction stage 10 on which a substrate S as a processing object is placed, an irradiation head 20 that irradiates an excimer laser beam, a mask M that sets laser beam transmitting sites and non-transmitting sites correspondingly to a processing shape, and a mask stage 30 on which the mask M is placed. The laser processing device 1 also includes an oscillator 40 that oscillates an excimer laser beam and an optical system 50 that collects an excimer laser beam.

### Configuration of Respective Portions

The substrate attraction stage 10 holds the substrate S as a processing object by vacuum attraction or the like and is movable in the X and Y directions along the surface of the substrate S. The irradiation head 20 is an emission end from which an excimer laser beam is emitted to the substrate S and has a mechanism movable along at least one of the X and Y directions. Owing to this configuration, it is possible to adjust a laser beam irradiation position on the substrate S. Also, the irradiation head 20 is movable along the height direction (Z direction) from the substrate S when the necessity arises.

The mask stage 30 is a stage on which to place the mask M according to an embodiment of the present invention described below. The oscillator 40 is a device that generates an excimer {HYPERLINK “http://ja.wikipedia.org/wiki/2.261264E+2893%AC8.602393E+2 893%BC2.261264E+2893%B68.602393E+2893%BC” ¥o “laser”, laser beam} using a mixed gas of {HYPERLINK “http://ja.wikipedia.org/wiki/2.261264E+2987ACAC188.602393 E+2896%8F2.507721E+28950832.261264E+28972.261264E+2894A0” ¥o “the elements of group 18”, rare gas} and {HYPERLINK “http://ja.wikipedia.org/wiki/2.261264E+2897ACAC178.602393 E+2896%8F2.507721E+2895%831.280567E+02571.280567E+0254A0” ¥o “the elements of group 17”, halogen}. The optical system 50 includes a lens that collects an excimer laser beam emitted from the oscillator 40.

The respective portions described above are attached to a vibration-free stand 60 so as to suppress transmission of external vibrations to the respective portions.

The laser processing device 1 scans an irradiation region by moving the substrate attraction stage 10 while irradiating an excimer laser beam onto the surface of the substrate S via the mask M having openings of a predetermined shape and thereby performs substrate processing according to the opening shape of the mask M. Such processing is achieved in accordance with the following processing principle.

### 2. Processing Principle of the OG Method

### Processing Principle View of the OG Method

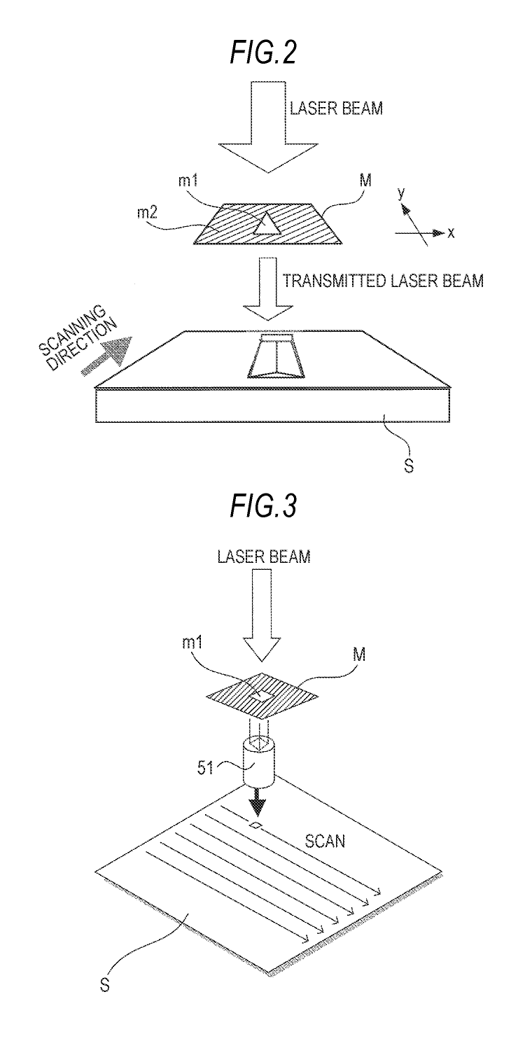

FIG. 2 is a view used to describe the processing principle of the OG method (Orthogonal method). More specifically, the OG method is a method of obtaining a 3D shape in a substrate S by scanning an irradiation region while irradiating a laser beam onto the substrate S as a processing object via a mask M having a desired opening.

The mask M is provided with an opening m1 of a predetermined shape that transmits a laser beam and a light shielding portion m2 that does not transmit a laser beam. The term, “the opening m1 in the mask M”, referred to herein means a portion that transmits light and includes a light-transmitting window in addition to an opening hole. When a laser beam is irradiated via the mask M, a laser beam of a matching shape with the opening m1 in the mask M is irradiated onto the substrate S.

When a laser beam of a matching shape with the opening m1 is irradiated onto the substrate S, a photochemical reaction called ablation takes place due to photon energy induced by a laser beam, which enables processing of the substrate S while suppressing thermal influences.

The processing shape is determined by a value of integral of an irradiation amount of a laser beam via the opening m1 in the mask M and a processing depth by a laser beam is determined according to the value of integral. To be more concrete, a processing depth becomes shallower as an opening area of the mask M becomes smaller because an irradiation amount becomes smaller.

When an irradiation region of a laser beam irradiated via the mask M is scanned on the substrate S, an irradiation amount takes a value of integral along the scanning direction. That is, given that a direction orthogonal to the scanning direction is the x axis and the scanning direction is the y axis for the shape of the opening m1 in the mask M, then the processing depth varies with a length of the opening m1 along the y axis direction.

More concretely, when the length of the opening m1 along the y axis direction becomes shorter, a value of integral of an irradiation amount along the scanning direction becomes smaller and hence the processing depth becomes shallower. On the contrary, when the length of the opening m1 along the y axis direction becomes longer, a value of integral of an irradiation amount along the scanning direction becomes larger and hence the processing depth becomes deeper. By scanning the irradiation region, a shape having the processing depth as the cross section continues in the scanning direction and a 3D shape extending in the scanning direction is formed.

For example, as is shown in FIG. 2, in the case of a mask M provided with a triangular opening m1 having the apex placed along the scanning direction, a portion corresponding to the apex of the triangle is processed most deeply and a concave of a triangular shape when viewed in a cross section is formed continuously in the scanning direction.

In a case where energy of an emitted laser beam is constant, the processing depth by laser beam irradiation has a relation with a scanning velocity of the irradiation region. More specifically, when the scanning velocity becomes slower, the substrate S is processed deeper because an irradiation amount per unit area increases. In view of the foregoing, it becomes possible to control a 3D shape formed in the substrate S by the shape of the opening m1 in the mask M and the setting of the scanning velocity of the irradiation region.

### Processing Method Using the OG Method

FIG. 3 is a schematic perspective view used to describe a relative position of a mask and a substrate as a processing object. A mask M is provided with an opening m1 of a predetermined shape and a laser beam is sent to a reduced projection lens 51 via the mask M.

A laser beam of a matching shape with the opening m1 in the mask M goes incident on the reduced projection lens 51. Accordingly, the irradiation region of a matching shape with the opening m1 in the mask M is reduced by a predetermined reduction ratio and irradiated onto the substrate S. The reduction projection lens 51 reduces the irradiation region, for example, to a fraction of the original size. By reducing the irradiation region, not only does it become possible to process a shape smaller than the actual size of the opening m1, but it also becomes possible to perform efficient processing owing to concentration of irradiation energy.

Either one or both of the substrate S and the optical system are moved relatively in one direction while a laser beam is being irradiated. Consequently, the laser beam irradiation region is scanned in a predetermined direction and processing is performed continuously along the scanning direction.

When scanning for one stage ends, the irradiation region is moved by one stage in a direction orthogonal to the scanning direction and irradiation of a laser beam and scanning are performed in the same manner. By repetitively performing the foregoing operation, processing is performed over a wide range of the substrate. By performing scanning of the laser beam irradiation region along one direction in several stages, it becomes possible to form a 3D shape continuing in the scanning direction.

After the 3D shape continuing in a first scanning direction is formed, the scanning is repeated in the same manner by setting a scanning direction of a laser beam to be orthogonal to the first scanning direction. Then, processing operations in two orthogonal directions are superimposed. A matrix of 3D shapes is thus formed.

More specifically, after the substrate S is processed along the scanning direction by scanning the irradiation region of a laser beam via the mask M along one direction, a laser beam is irradiated onto the processed substrate S by changing the scanning direction to be orthogonal to the scanning direction in the last time. Accordingly, the shape processed by the scanning in one direction is processed further in an orthogonal direction. A matrix of 3D shapes can be thus obtained.

For example, in a case where a 3D shape having a semi-circular shape when viewed in a cross section and extending along the scanning direction of a laser beam is formed, it becomes possible to perform processing to form a plurality of semi-circular shapes (for example, lens shapes) aligned in a matrix fashion by performing this processing in two orthogonal directions.

It should be noted, however, that an angle between two scanning directions when laser beams are scanned in two directions may be set to an angle other than the right angle. Accordingly, a matrix of 3D shapes having different aspect size ratios can be obtained.

### 3. Comparative Example

A comparative example with the embodiment of the present invention will now be described before embodiments of the present invention is described.

### Mask Configuration and Joining

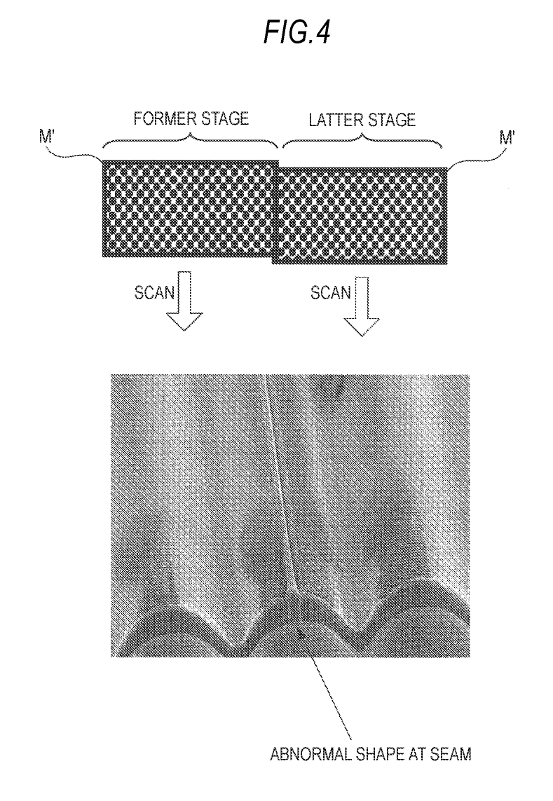

FIG. 4 is a view used to describe a comparative example of the processing by the OG method. A mask M used in the comparative example is provided with an opening forming region of a rectangular shape in which a plurality of openings are aligned vertically and horizontally. Referring to the drawing, portions indicated in white in a mask M′ represent openings and portions indicated in black represent light shielding portions. In FIG. 4, the mask M′ is used to show joining of irradiation regions via the mask M′ by the scanning in a first stage and by the scanning in a second stage. That is, because the shape of the mask M′ corresponds to the irradiation region of a laser beam, the irradiation region and joining of the irradiation regions are indicated by the mask M′ for ease of illustration.

The irradiation region of a laser beam via the mask M′ is scanned in the direction indicated by an arrow in the drawing. The irradiation region is displaced in a direction orthogonal to the scanning direction and those in the former stage and the latter stage are joined together. By the processing using the mask M′, the seam of the irradiation regions forms an angular-shaped portion in a processing shape.

The lower view in FIG. 4 is an enlarged picture of the processing shape falling on the seam of the irradiation regions. In the comparative example, a convex abnormal shape is formed in the irradiation regions at the seam portion. As means for removing such an abnormal shape, an overlap may be provided to the seam of the irradiation region in the former stage and the irradiation region in the latter stage. Because a light irradiation amount in the seam portion increases, the convex abnormal shape becomes smaller. However, the overlapping makes a pitch of 3D shapes correspondingly narrower in the seam portion alone. It thus becomes quite difficult to obtain an exact shape that continues at a regular pitch.

### Surface Shape of Joined Portion

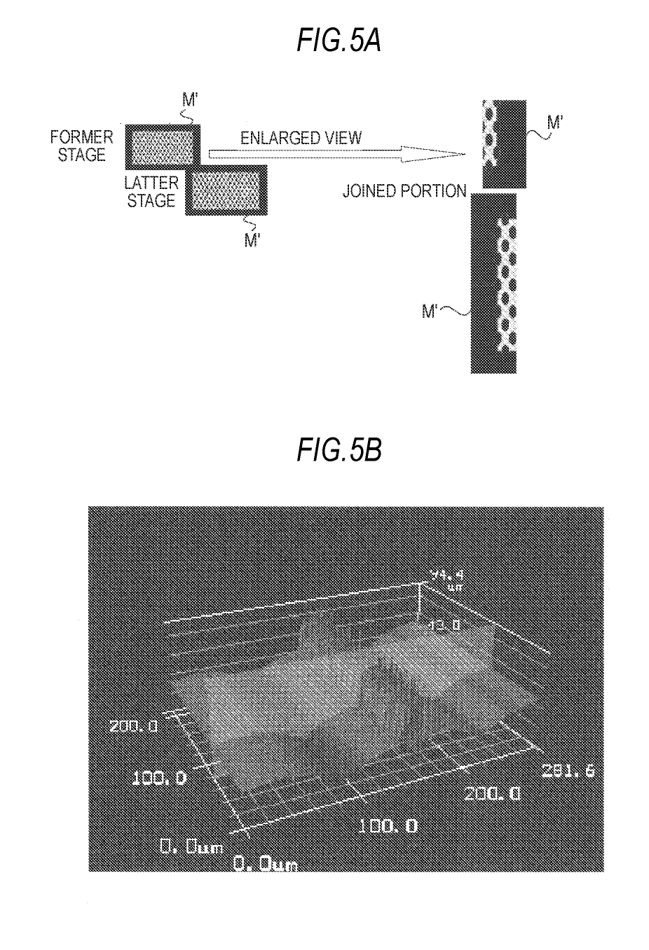

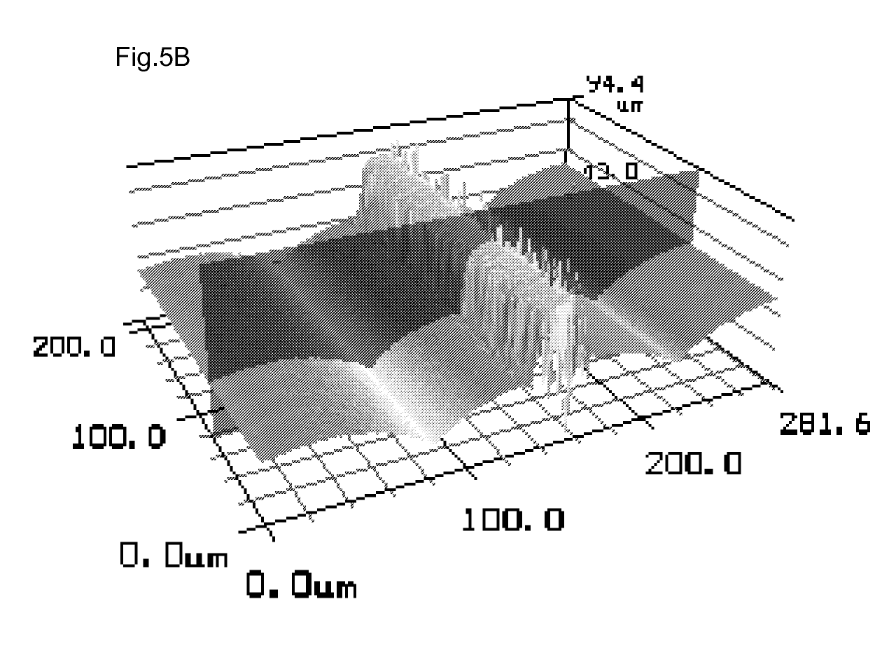

FIG. 5A and FIG. 5B are views showing the surface shape of the seam potion of the irradiation regions shown in FIG. 4 and a measurement result, respectively. As is shown in FIG. 5A, in a case where the irradiation regions via the mask by the scanning in a given stage and by the scanning in the following stage are joined together, a convex abnormal shape develops in the joined portion.

FIG. 5B is a view showing a measurement result of the surface shape of the joined portion. An irradiation amount in the joined portion becomes smaller than in the other portions and a processing depth becomes shallower. This portion therefore remains in a convex shape.

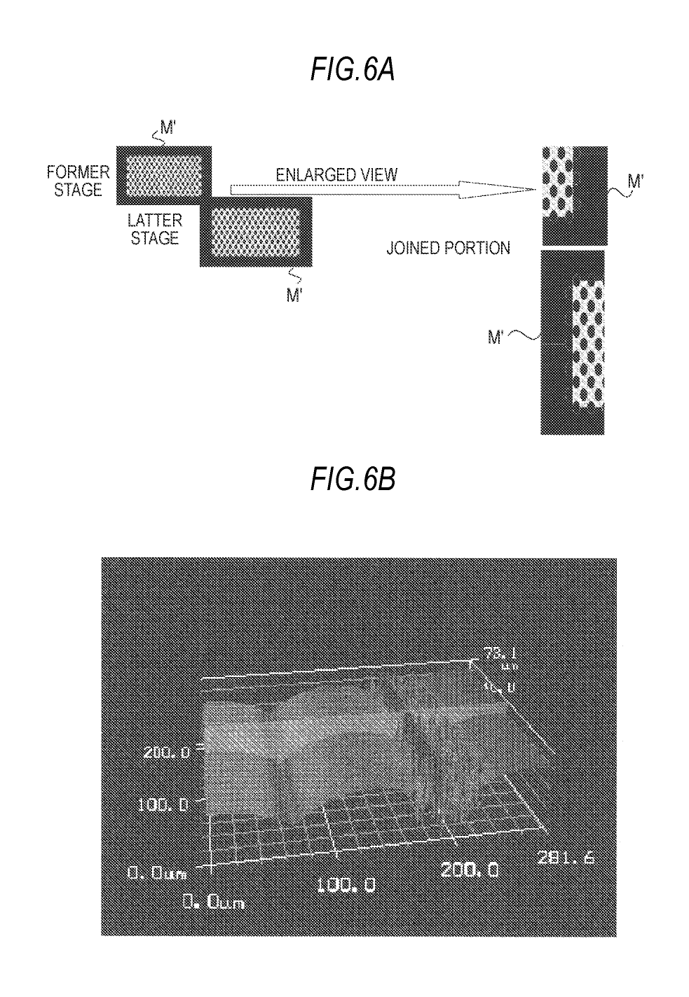

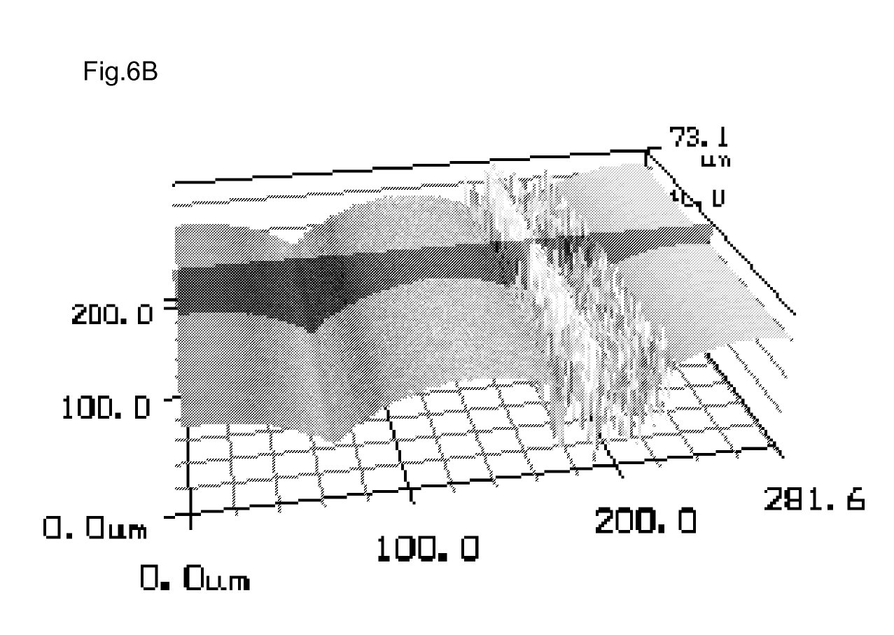

FIG. 6A and FIG. 6B are views showing the surface shape and a measurement result, respectively, in a case where the processing shape at the seam of the irradiation regions is a trough shape. As is shown in FIG. 6A, in a case where the irradiation regions via the mask by the scanning in a given stage and by the scanning in the following stage are joined together, a convex abnormal shape develops in the joined portion.

FIG. 6B is a view showing a measurement result of the surface shape of the joined portion. As with the case above, an irradiation amount in the joined portion becomes smaller than in the other portions and a processing depth becomes shallower. This portion therefore remains in a convex shape.

As means for removing such an abnormal shape, an overlap may be provided to the seam of the irradiation region in the former stage and the irradiation region in the latter stage as with the case described above. However, the overlapping makes the pitch of 3D shapes correspondingly narrower in the seam portion. It thus becomes quite difficult to obtain an exact shape that continues at a regular pitch.

The embodiment of the present invention solves the problems in the comparative example as above. More specifically, because a 3D processing shape by the OG method relates to a laser transmitting area of the mask, a laser beam is irradiated by superimposing the irradiation regions via the mask in the former stage and the latter stage at the seam portion. In this instance, the embodiment of the present invention is characterized in that an irradiation amount irradiated to a region where the irradiation regions are superimposed and an irradiation amount irradiated to a region where the irradiation regions are not superimposed are made equal in each irradiation line.

### 4. Mask According to Embodiment of the Present Invention

### Mask Configuration

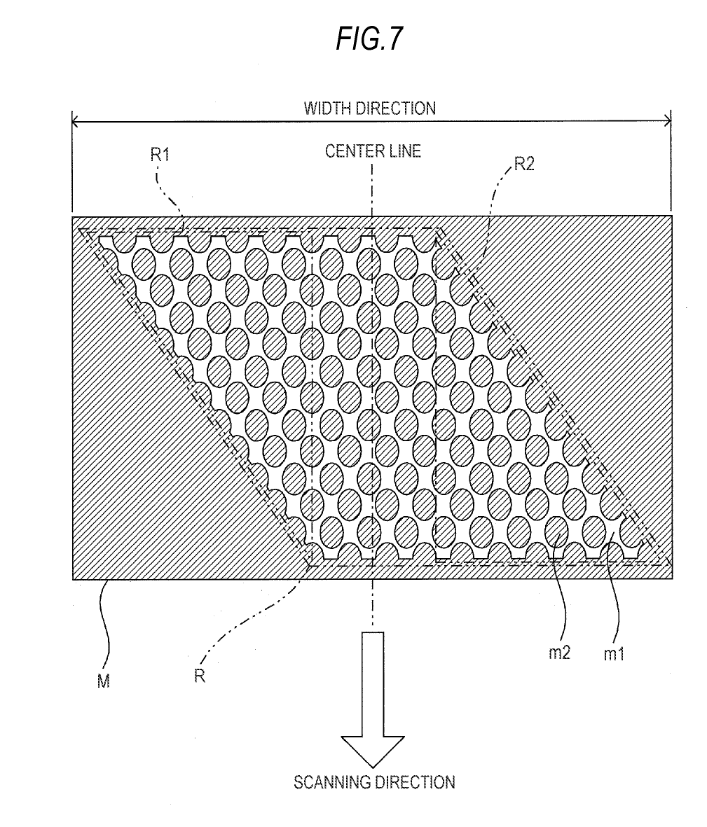

FIG. 7 is a view used to describe a mask used by an optical processing method according to an embodiment of the present invention. Referring to the drawing, portions indicated in white in a mask M represent openings m1 and hatched portions indicate light shielding portions m2. The mask M includes an opening forming region R in which a plurality of openings m1 are aligned vertically and horizontally. In FIG. 7, the width direction of the mask M is the horizontal direction in the drawing and the scanning direction of the irradiation region of a laser beam via the mask M is the vertical direction in the drawing.

In the opening forming region R in the mask M, a plurality of the openings m1 are provided in line along the width direction of the mask M. Also, a plurality of the openings m1 in line are provided in a plurality of lines in a direction orthogonal to the width direction of the mask M.

### First Region and Second Region

Further, the opening forming region R is provided with a region (first region R1) including a diagonal line at a predetermined angle with respect to a central axis in the vertical direction in the drawing in a predetermined region on one side of the central axis. Also, the opening forming region R is provided with a region (second region R2) including a diagonal line at the same angle as the predetermined angle in a predetermined region on the other side of the central axis. In other words, triangular regions provided on one side and on the other side of the center line in the opening forming region R of a parallelogram shape are the first region R1 and the second region R2.

In the first region R1 and the second region R2, which are regions including the diagonal lines, a plurality of the openings m1 are provided in such a manner that the number of the openings m1 in lines corresponding to the diagonal line portions varies line by line. To be more concrete, a plurality of the openings m1 are provided in such a manner that the numbers of the openings m1 vary gradually line by line between the first region R1 and the second region R2.

In the mask M configured as above, portions in the irradiation regions corresponding to the first region R1 and the second region R2 are superimposed in an irradiation region of irradiation across one width of the mask M by the scanning in a given stage and an irradiation region in the following stage. Moreover, the opening area is set so that light irradiation amounts become equal in all the irradiation lines corresponding to the respective openings m1. It thus becomes possible to obtain a seamless smooth processing shape.

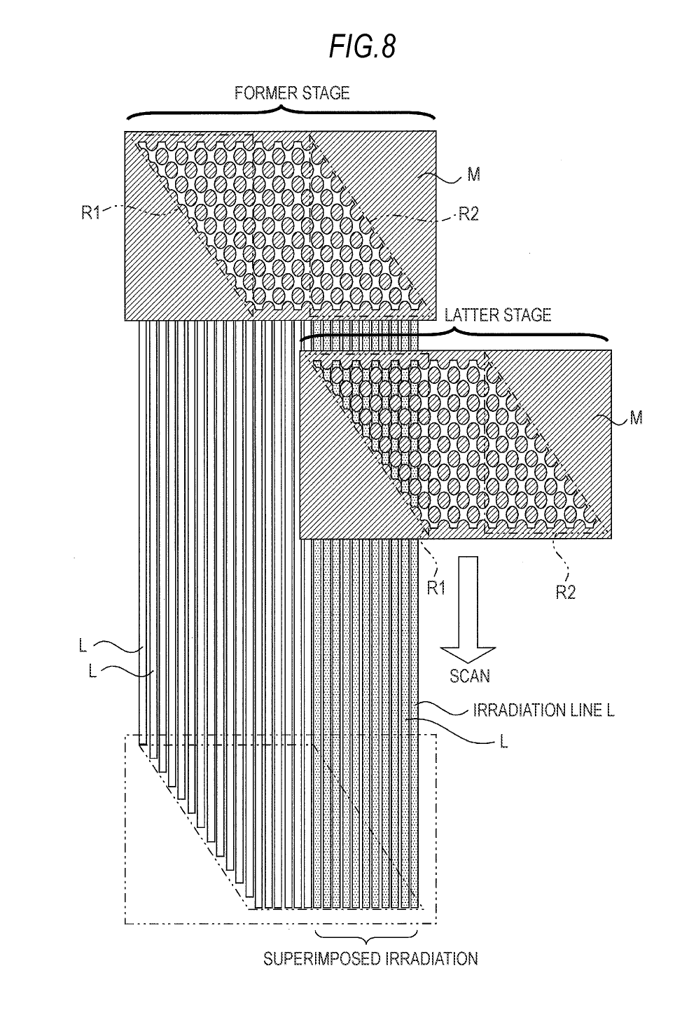

FIG. 8 is a schematic view used to describe superimposition of the irradiation regions and an irradiation amount. The view shows a state where a part of the irradiation region by the scanning in the latter stage using the mask M is superimposed on the irradiation region in the former stage.

More specifically, by the scanning in the former stage, an irradiation line L along the scanning direction is formed for each of a plurality of the openings m1 aligned in the width direction of the mask M. Of these irradiation lines L, because the first region R1 and the second region R2 have fewer openings along the scanning direction than the other region, a light irradiation amount in the irradiation lines L corresponding to the openings m1 in these regions becomes smaller correspondingly to the number of the openings m1.

In other words, in the irradiation lines L corresponding to the first region R1 and the second region R2, a light irradiation amount becomes smaller as the openings along the scanning direction becomes fewer. According to the embodiment of the present invention, of the irradiation lines L by the scanning in the former stage, the irradiation lines L in the first region R1 by the scanning in the latter stage are superimposed on the irradiation lines L in the second region R2.

According to this superimposition, the irradiation lines L in the first region R1 by the scanning in the latter stage in ascending order of irradiation amounts are superimposed on the irradiation lines L in the second region R2 by the scanning in the former stage in descending order of irradiation amounts. Consequently, a total irradiation amount becomes equal in all the irradiation lines L.

There are irradiation lines that are superimposed in the former stage and the latter stage and irradiation lines that are not superimposed. However, irradiation amounts of these irradiation lines are set to be equal. FIG. 8 shows superimposition of the former stage and the latter stage. However, the same applies to other stages and the irradiation lines are superimposed in the latter stage and the following stage and in the following stage and the next following stage and so on. Accordingly, even when a part of the irradiation lines in the former stage and a part of the irradiation lines in the latter stage are superimposed, an irradiation amount becomes equal in all the irradiation lines.

The irradiation lines corresponding to the first region R1 in the first stage and the irradiation lines corresponding to the second region in the last stage are not superimposed on those in the preceding stage and the following stage, respectively. Hence, irradiation amounts of these irradiation lines are not equal to the irradiation amounts of the other irradiation lines. However, this portion can be omitted so as not to actually contribute to shape processing by setting this portion outside the effective region of the substrate.

### 5. Optical Processing Method According to Embodiment of the Present Invention

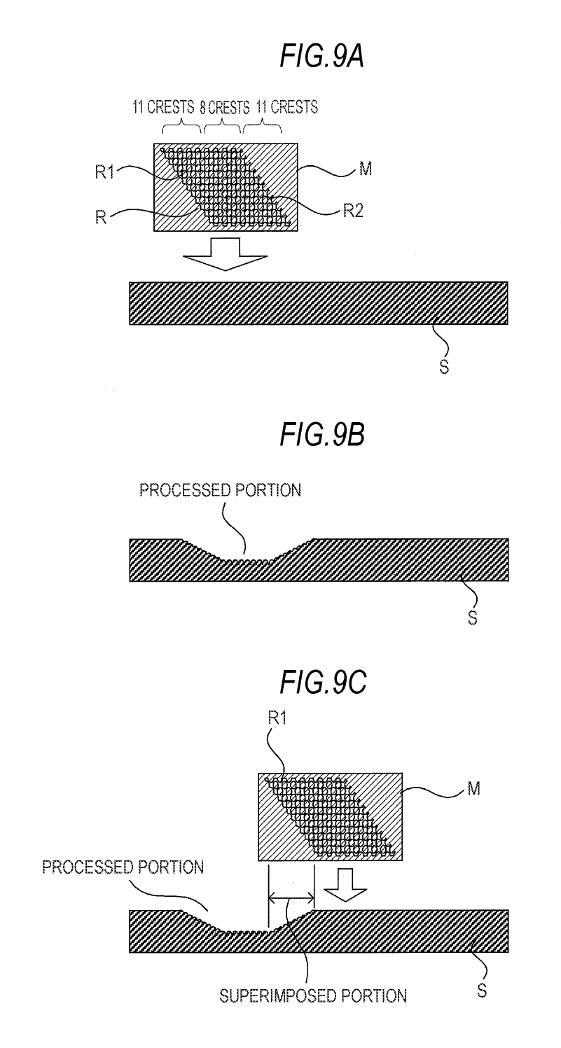

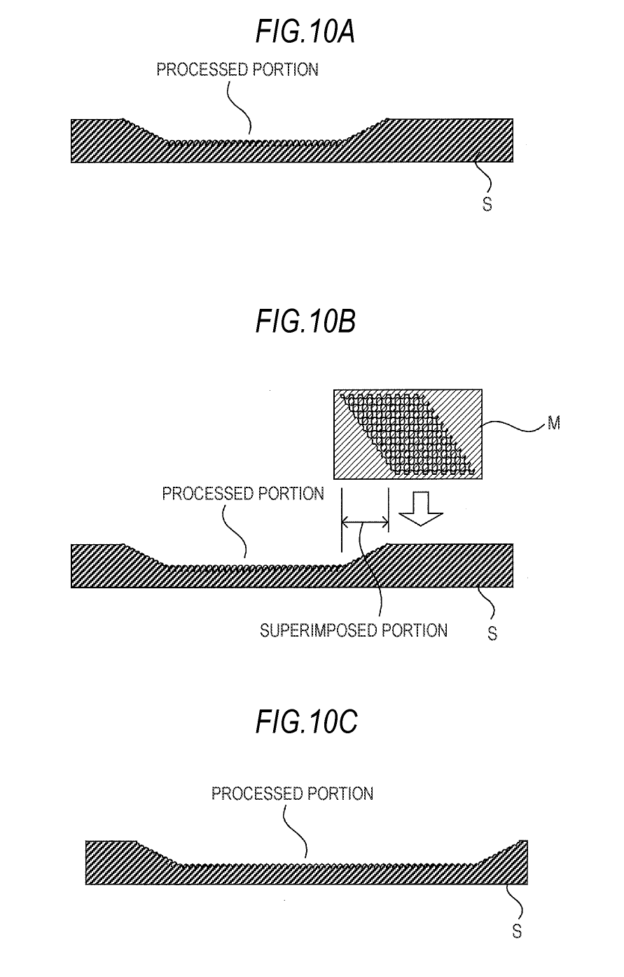

FIG. 9A through FIG. 9C and FIG. 10A through FIG. 10C are schematic views used to describe an optical processing method according to an embodiment of the present invention. Herein, the mask M according to an embodiment of the present invention shown in FIG. 7 is used. In the drawing, the mask M is shown when viewed in a plane whereas the substrate S as a processing object is shown when viewed in a cross section. Also, with the mask M viewed in a plane, the direction indicated by an arrow in the drawing indicates the scanning direction of the irradiation region. Meanwhile, with the substrate S viewed in a cross section, a direction perpendicular to the sheet surface is the scanning direction of the irradiation region.

Initially, as is shown in FIG. 9A, an excimer laser beam is irradiated via the mask M and the irradiation region is scanned. Consequently, as is shown in FIG. 9B, the substrate S is processed by each of the irradiation lines corresponding to the respective openings in a stage across one width of the mask.

With this processing, a processing depth of the irradiation lines corresponding to the first region R1 and the second region R2 of the mask M becomes shallower toward the outer side of the mask M. This corresponds to the configuration that the openings becomes fewer toward the outer side in the portions of the diagonal lines in the first region R1 and the second region R2. That is, a processing depth becomes shallower as the openings become fewer because a light irradiation amount becomes smaller.

In the case shown in FIG. 9B, one irradiation line is formed corresponding to the openings aligned along the scanning direction and one convex shape is formed. A processing depth varies gradually with eleven crests corresponding to the first region R1 and eleven crests corresponding to the second region R2 whereas a processing depth remains the same with eight crests at the center.

Subsequently, as is shown in FIG. 9C, the light irradiation region via the mask M is displaced by one stage.

In this instance, of the region processed in the former stage, a processed portion (irradiation lines) corresponding to the second region R2 of the mask M and the irradiation region (irradiation lines) corresponding to the first region R1 of the mask M in the latter stage are superimposed.

In the case shown in FIG. 9C, eleven crests formed correspondingly to the second region R2 in the former stage are superimposed on the irradiation region (irradiation lines) corresponding to the first region R1 in the latter stage. When the irradiation region is scanned in the latter stage in this state, a processed state as shown in FIG. 10A is obtained.

More specifically, an irradiation amount in the respective superimposed irradiation lines is a sum of irradiation amounts in the first region R1 and the second region R2 of the mask M. Because this irradiation amount is equal to an irradiation amount in each non-superimposed irradiation line, a processing depth of the non-superimposed irradiation lines and a processing depth of the superimposed irradiation lines become equal. Consequently, the same processing shape continues seamlessly.

Then, as is shown in FIG. 10B, the light irradiation region via the mask M is further displaced by one stage and irradiation of a laser beam and scanning are performed by setting the superimposed region in the same manner as above. By repeating the above operation in the processing region of the substrate S, it becomes possible to obtain a seamless 3D shape as is shown in FIG. 10C.

Also, by performing the 3D shape processing by moving the irradiation region in the scanning direction as shown in FIG. 9A through FIG. 10C repetitively in two mutually orthogonal directions, the shape processing operations in the two orthogonal directions are superimposed. A matrix of 3D shapes can be thus formed.

For example, with the processing to form a 3D shape in which a semicircular shape when viewed in a cross section extends along the scanning direction of a laser beam, it becomes possible to perform processing to obtain a plurality of semi-circular shapes (for example, lens shapes) aligned in a matrix fashion by performing this processing in two orthogonal directions.

It should be noted, however, that angles between two scanning directions when laser beams are scanned in two directions may be set to an angle other than the right angle. Accordingly, a matrix of 3D shapes having different aspect size ratios can be obtained.

### 6. Other Examples of Mask Configuration According to Embodiment of the Present Invention

### Example 1

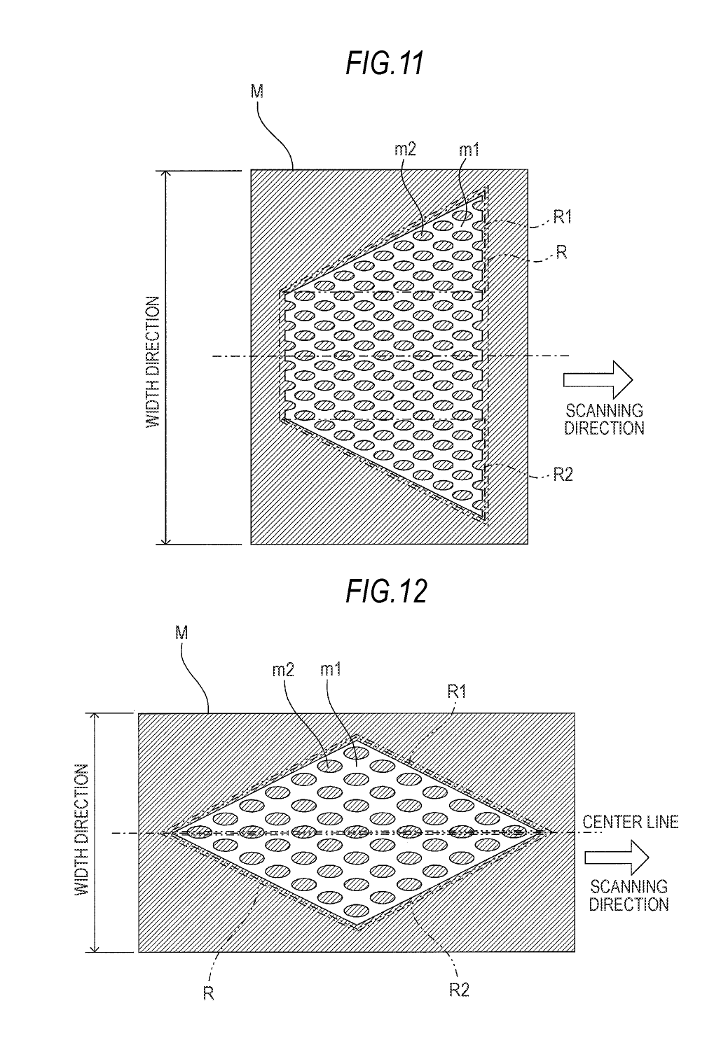

FIG. 11 is a plan view used to describe another example of the mask configuration (Example 1) according to the embodiment of the present invention. Herein, the vertical direction in the drawing is the width direction of the mask M and the horizontal direction in the drawing is the scanning direction of the light irradiation region via the mask M.

The mask M includes an opening forming region R in which a plurality of openings m1 are aligned vertically and horizontally. In the opening forming region R, there are a first region R1 and a second region R2 provided, respectively, on one side and on the other side of the central axis along the scanning direction. The first region R1 and the second region R2 are line symmetric with respect to the central axis.

With the mask M configured as above, irradiation lines corresponding to the first region R1 and those corresponding to the second region R2 are superimposed in an irradiation region in a given stage by irradiation across one with of the mask M and an irradiation region in the following stage. Even when the first region R1 and the second region R2 are line symmetric with respect to the central axis, an opening area is set in such a manner that a light irradiation amount in superimposed irradiation lines and a light irradiation amount in non-superimposed irradiation lines become equal. Also, an opening area is set in such a manner that a light irradiation amount becomes equal in all the irradiation lines. It thus becomes possible to obtain a seamless smooth processing shape.

### Example 2

FIG. 12 is a plan view used to describe still another example of the mask configuration (Example 2) according to the embodiment of the present invention. Herein, the vertical direction in the drawing is the width direction of the mask M and the horizontal direction in the drawing is the scanning direction of the light irradiation region via the mask M.

The mask M has a first region R1 and a second region R2, respectively, on one side and on the other side of the central axis along the scanning direction. Accordingly, the mask M as a whole has an opening forming region R of a rhombic shape.

Even with the mask M having the opening forming region R of a rhombic shape as above, irradiation lines corresponding to the first region R1 and those corresponding to the second region R2 are superimposed in the irradiation region in a given stage by irradiation across one width of the mask M and the irradiation region in the following stage. Because a light irradiation amount in the superimposed irradiation lines becomes equal in all the stages, even when light is irradiated through a superimposed region, it becomes possible to obtain a seamless smooth processing shape.

### Example 3

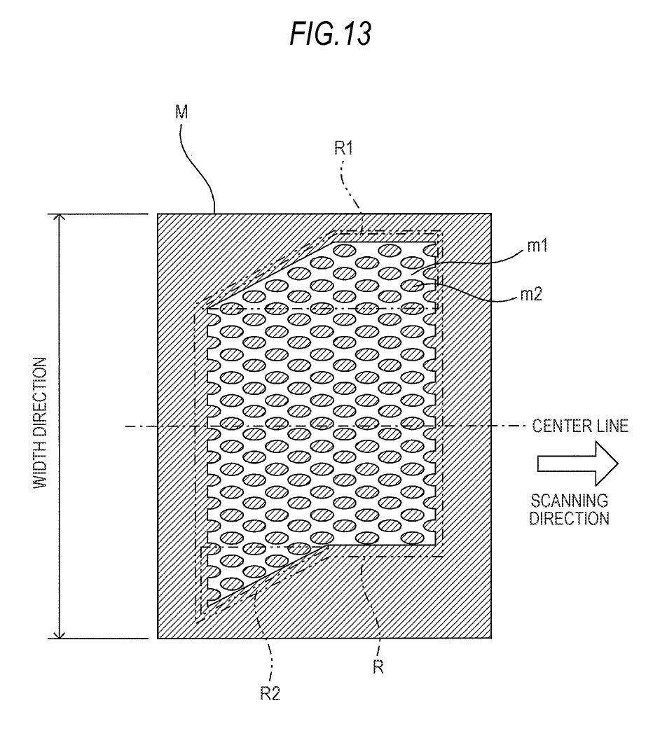

FIG. 13 is a plan view used to describe still another example of the mask configuration (Example 3) according to the embodiment of the present invention. Herein, the vertical direction in the drawing is the width direction of the mask M and the horizontal direction in the drawing is the scanning direction of the light irradiation region via the mask M.

The mask M has an opening forming region R in which a plurality of openings m1 are aligned vertically and horizontally. In the opening forming region R, there are a first region R1 and a second region R2 provided, respectively, on one side and on the other side of the central axis along the scanning direction.

The first region R1 is of a trapezoidal shape and a plurality of openings m1 along the width direction of the mask M are provided in such a manner the number thereof varies in part of the lines. Meanwhile, the second region R2 is of a triangular shape. Herein, a missing portion of the trapezoidal shape corresponding to a circumscribed rectangle of the first region R1 and the triangle of the second region R2 are of the same size.

With the mask M configured as above, irradiation lines corresponding to the first region R1 and those corresponding to the second region R2 are superimposed in the irradiation region in a given stage by irradiation across one width of the mask M and the irradiation region in the following stage. In this instance, a light irradiation amount in the superimposed irradiation lines and a light irradiation amount in the non-superimposed lines becomes equal. Further, a light irradiation amount becomes equal in all the irradiation lines. It thus becomes possible to obtain a seamless smooth processing shape.

### Example 4

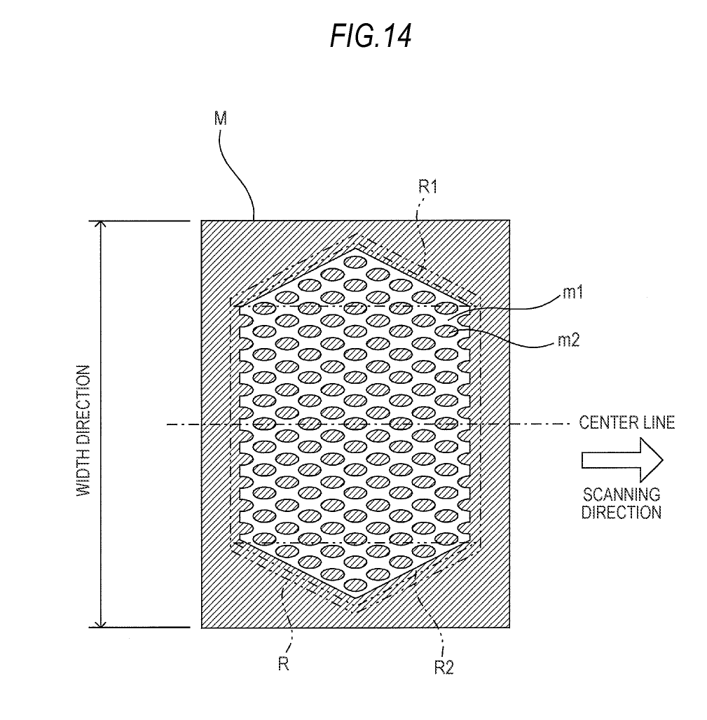

FIG. 14 is a plan view used to describe still another example of the mask configuration (Example 4) according to the embodiment of the present invention. Herein, the vertical direction in the drawing is the width direction of the mask M and the horizontal direction in the drawing is the scanning direction of the light irradiation region via the mask M.

The mask M has an opening forming region R in which a plurality of openings m1 are aligned vertically and horizontally. In the opening forming region R, there are a first region R1 and a second region R2 provided, respectively, on one side and on the other side of the central axis along the scanning direction. The first region R1 and the second region R2 are of a triangular shape and line symmetric with respect to the central axis.

With the mask M configured as above, irradiation lines corresponding to the first region R1 and those corresponding to the second region R2 are superimposed in the irradiation region in a given stage by irradiation across one width of the mask M and the irradiation region in the following stage. Even when the first region R1 and the second region R2 are line symmetric with respect to the central axis, an opening area is set in such a manner that a light irradiation amount in superimposed irradiation lines and a light irradiation amount in non-superimposed irradiation lines become equal. Also, an opening area is set in such a manner that a light irradiation amount becomes equal in all the irradiation lines. It thus becomes possible to obtain a seamless smooth processing shape.

### Example 5

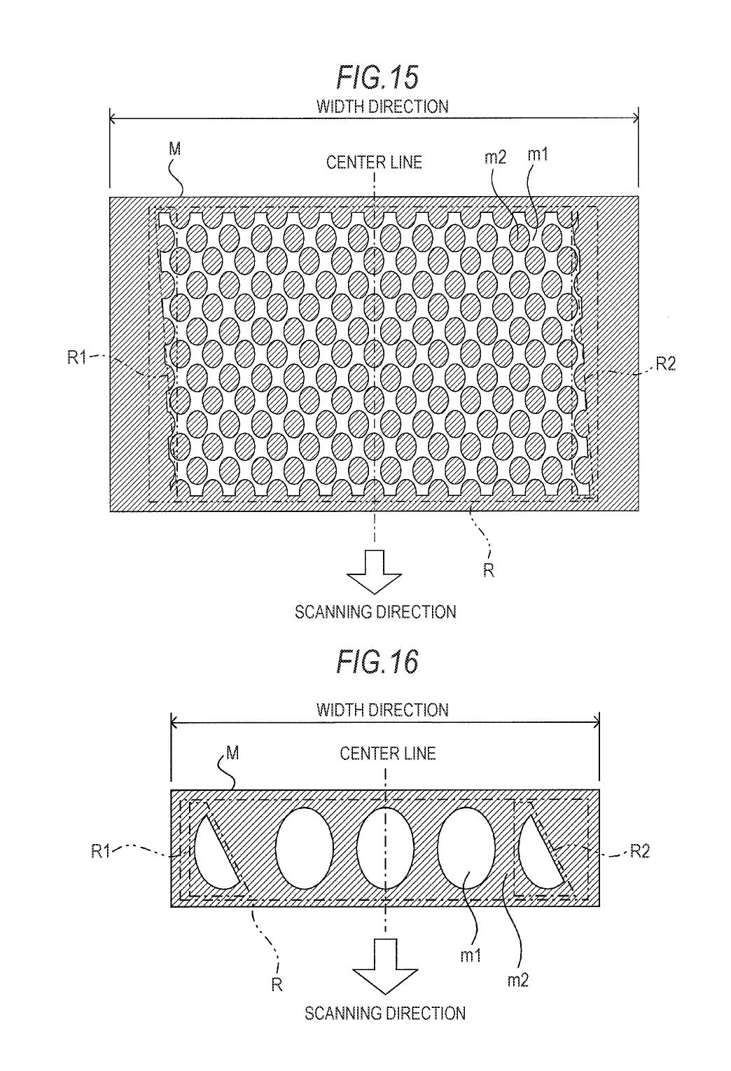

FIG. 15 is a plan view used to describe still another example of the mask configuration (Example 5) according to the embodiment of the present invention. Herein, the horizontal direction in the drawing is the width direction of the mask M and the vertical direction in the drawing is the scanning direction of the light irradiation region via the mask M.

The mask M has an opening forming region R in which a plurality of openings m1 are aligned vertically and horizontally. In the opening forming region R, there are a first region R1 and a second region R2 provided, respectively, on one side and on the other side of the central axis along the scanning direction. The first region R1 and the second region R2 are triangular regions each formed of a line of openings m1 aligned in the vertical direction (scanning direction) in the drawing. More specifically, with one line of the openings at either end of the opening forming region R, an area of the openings becomes gradually smaller along the scanning direction in the first region R1 whereas an area of the openings becomes gradually larger along the scanning direction in the second region R2.

### Example 6

FIG. 16 is a plan view used to describe another example of the mask configuration (Example 6) according to the embodiment of the present invention. Herein, the horizontal direction in the drawing is the width direction of the mask M and the vertical direction in the drawing is the scanning direction of the light irradiation region via the mask M.

The mask M has an opening forming region R in which a plurality of openings m1 are aligned vertically and horizontally. In the opening forming region R, there are a first region R1 and a second region R2 provided, respectively, on one side and on the other side of the central axis along the scanning direction. The first region R1 and the second region R2 are triangular regions each formed of one opening m1 at either end. More specifically, with one opening m1 at either end of the opening forming region R, the opening m1 becomes gradually wider along the scanning direction in the first region R1 whereas the opening m1 becomes gradually narrower along the scanning direction in the second region R2.

In each of FIG. 15 and FIG. 16, irradiation lines corresponding to the first region R1 and those corresponding to the second region R2 are superimposed in an irradiation region in a given stage by irradiation across one width of the mask M and the irradiation region in the following stage. In this instance, a light irradiation amount in the superimposed irradiation lines and a light irradiation amount in the non-superimposed irradiation lines become equal. Further, a light irradiation amount becomes equal in the irradiation lines corresponding to the respective openings. It thus becomes possible to obtain a seamless smooth processing shape.

### 7. Example of Another Laser Processing Device Device Configuration

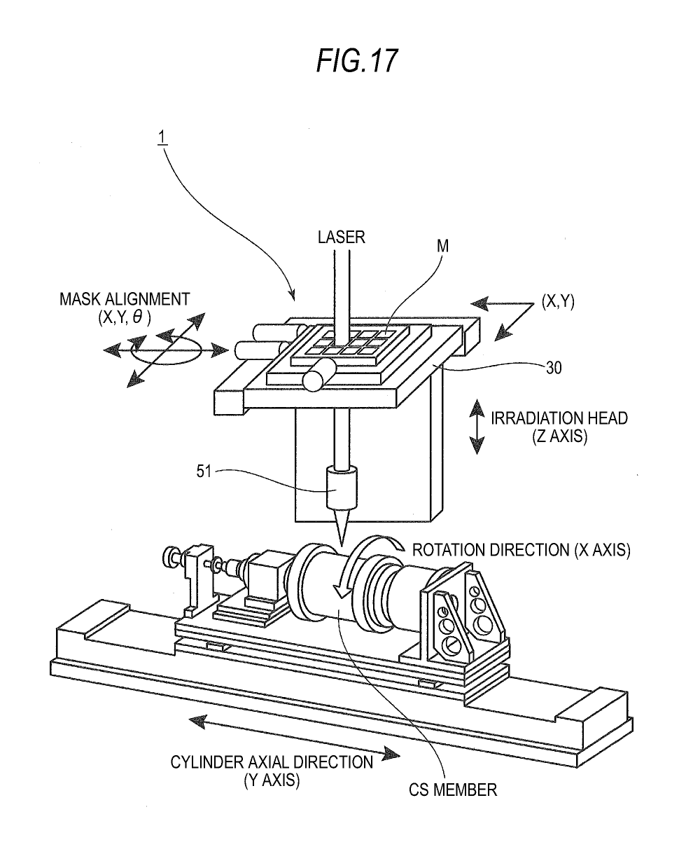

FIG. 17 is a schematic perspective view used to describe an example of another laser processing device to which the optical processing method according to the embodiment of the present invention is applied. With the laser processing device described above with reference to FIG. 1, the processing object is a plate-like substrate. A laser processing device 1 shown in FIG. 17 is different in that the processing object is a cylindrical member CS.

The cylindrical member CS is made, for example, of a resin material and attached in a rotatable manner in the circumferential direction (X direction) of the cylinder. Also, the cylindrical member CS is attached in a movable manner in the axial direction (Y direction) of the cylinder.

The mask M is placed on the mask stage 30 and is movable along the two axes in the mask plane directions and the rotational axis. A laser beam (for example, an excimer laser beam) emitted from an unillustrated laser oscillator passes through the mask M and is reduced by the reduced projection lens 51, after which the laser beam is irradiated onto the surface of the cylindrical member CS.

### Processing Method

When the processing is performed by the laser processing device 1, the cylindrical member CS is moved in the cylinder axial direction (Y direction) while a laser beam is irradiated onto the surface of the cylindrical member CS via the mask M. The irradiation region is thus scanned.

When irradiation across one width of the mask M and scanning end, the cylindrical member CS is rotated along the rotation direction (X direction) so as to rotate the irradiation region by the mask M by one stage. The irradiation position across one width of the mask M is consequently displaced by one stage. As has been described above, in a case where the mask M according to the embodiment of the present invention is used, the irradiation regions in the former stage and in the latter stage are superimposed in part.

Thereafter, the cylindrical member CS is moved in the cylinder axial direction (Y direction) while a laser beam is irradiated onto the surface of the cylindrical member CS via the mask M. This operation is repetitively performed across the entire circumferential surface of the cylindrical member CS. Seamless processing with no seams in the circumferential direction is thus achieved.

The embodiment of the present invention as above is applicable to a large-scale display or the like owing to the ability of processing a large-area substrate smoothly. Also, because seamless processing can be achieved even on a cylindrical shape, it becomes possible to form an original plate of a metal die used for a functional film or the like. Further, the embodiment of the present invention as above is also applicable to a diffusion plate used in a large scale display or the like. In either case, a processing shape has regular pitches and an exact shape can be formed according to the embodiment of the present invention.

### 8. Mask Configuration

The mask configuration applied in an embodiment of the present invention will now be described. According to the OG method described above, a processing depth (herein, an etching depth) is determined by a light amount of a laser beam passing through the opening in the mask. Accordingly, the processing depth is set according to the size (length) of the opening along the scanning direction.

### Fundamental Idea

In order to obtain a desired processing shape by the OG method using the mask, many parameters, such as irradiation energy of a laser beam, a substrate feeding rate, and an aperture of the mask, are necessary and it takes a large amount of labor to set a mask that fits an individual processing shape. Also, in a case where a mask by the OG method is designed by the CAD (Computer Aided Design), complicated conversion software is necessary to draw a multidimensional polynomial curve by the CAD.

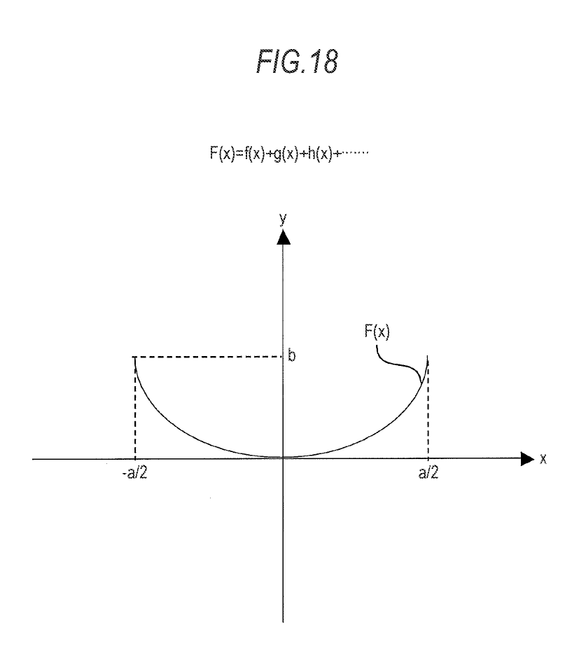

In order to eliminate such inconveniences, the embodiment of the present invention provides an example of the configuration that readily forms a mask used to form a 3D shape having a multidimensional polynomial curve. Initially, a multidimensional polynomial (1) and a curve thereof shown in FIG. 18 are concerned.

The multidimensional polynomial (1) is expressed as:

F(x)=f(x)+g(x)+h(x).

Next, a mask used to obtain a convex processing shape conforming to the profile of the multidimensional polynomial (1) is concerned. Herein, a processing depth of a laser beam for the processing shape is determined by a value of integral corresponding to the shape of a rim of the opening portion in the mask where a laser beam is transmitted. Hence, in order to obtain a desired convex shape as shown in FIG. 19 in the substrate S, the sectional area S(x) to be etched away from the substrate surface as is indicated by a hatched portion in FIG. 19 is found in accordance with an equation (2) below.

The equation (2) is expressed as:

S(x)=∫(f(x)+g(x)+h(x) . . . )dx.

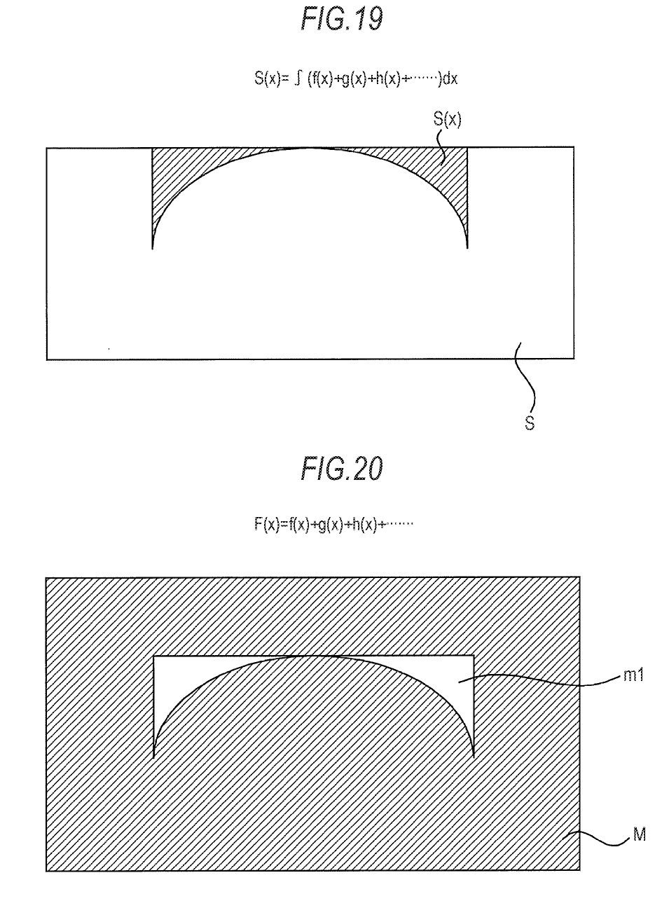

In order to obtain this processing shape, the shape of an opening m1 in the mask M as shown in FIG. 20 is necessary. Hence, according to the embodiment of the present invention, individual masks for f(x), g(x), and h(x) corresponding to the respective monomials of the function F(x) are used and a laser beam is irradiated repetitively on the same position via these masks. Because the processing shape is determined by a value of integral of the opening portion from which an irradiated laser beam comes out, it becomes possible to obtain a processing shape corresponding to a desired multidimensional polynomial.

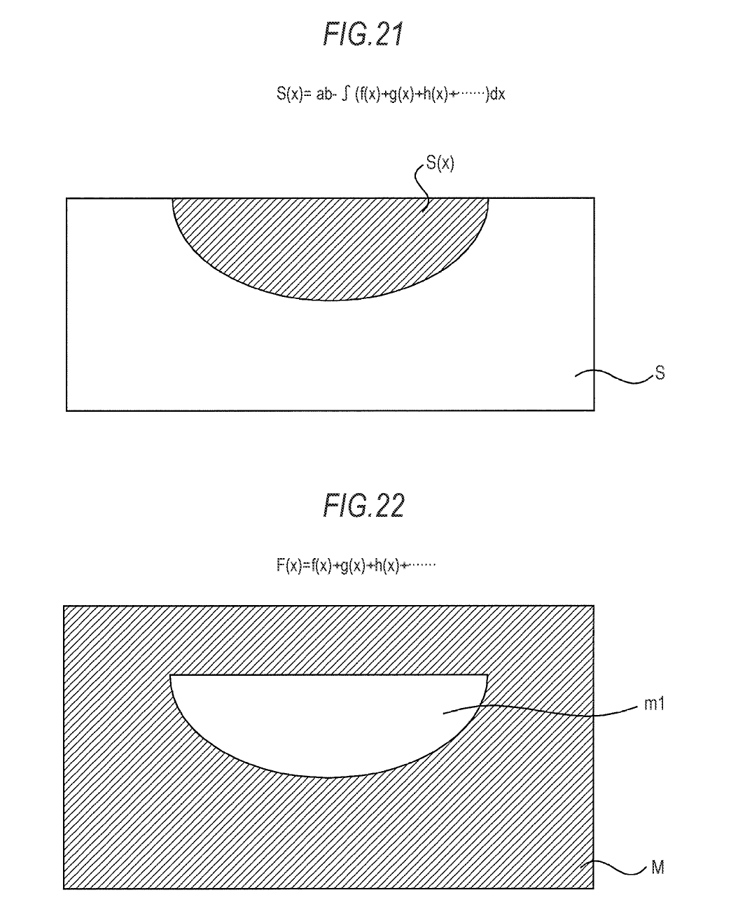

FIG. 21 is a schematic view used to describe an etching sectional area of the substrate to obtain a convex shape. FIG. 22 is a schematic view used to describe a mask shape to obtain the concave shape. Herein, in order to obtain the concave shape, individual masks for f(x), g(x), and h(x) corresponding to the concave are necessary.

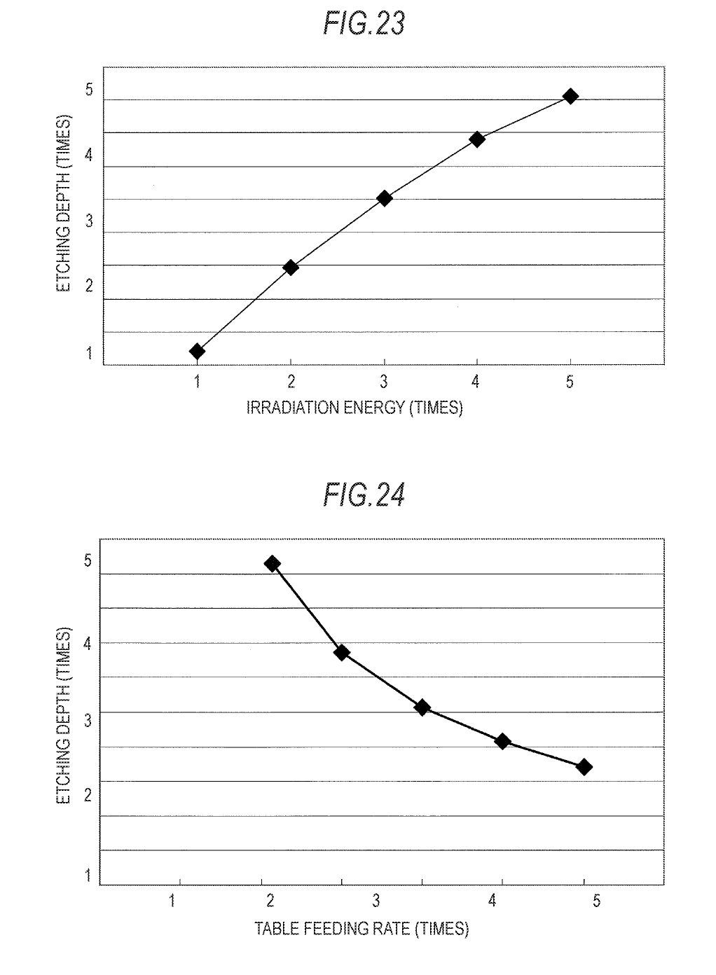

FIG. 23 is a view showing a relation between the irradiation energy of a laser beam taken on the abscissa and an etching depth taken on the ordinate. FIG. 24 is a view showing a relation between a substrate table feeding rate taken on the abscissa and an etching depth taken on the ordinate. From these relations, it is understood that the etching depth becomes deeper as the irradiation energy of a laser beam becomes higher. It is also understood that the etching depth becomes shallower as the substrate table feeding rate becomes higher.

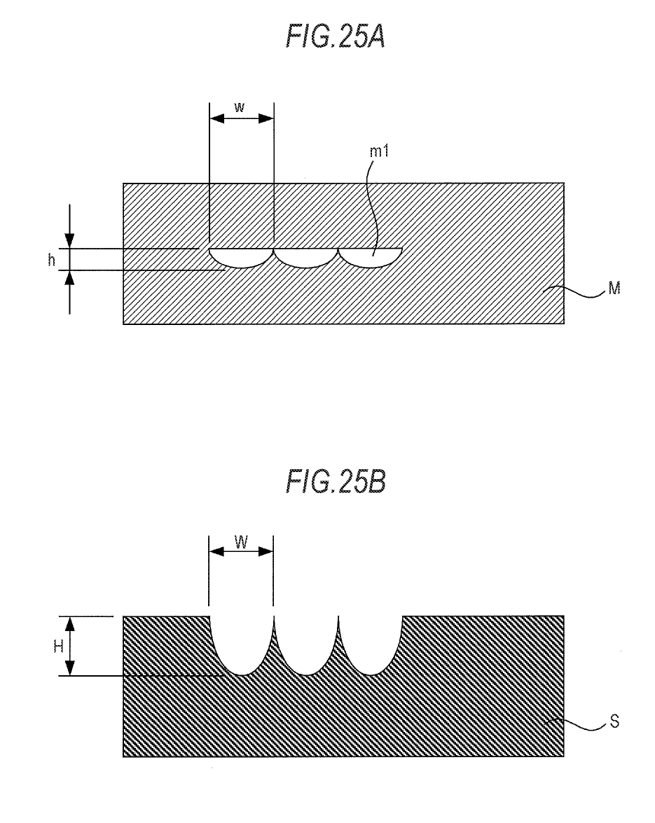

FIG. 25A and FIG. 25B are schematic views showing a mask and the cross section of the processing shape obtained by this mask, respectively. Herein, given that an aspect ratio, w/h, of one opening m1 in the mask M shown in FIG. 25A is a times greater than an aspect ratio, W/H, of the actually obtained processing shape shown in FIG. 25B. Then, a relation expression is expressed by an equation (3) below.

The equation (3) is expressed as:

a=(w/h)/(W/H).

The coefficient a varies with the irradiation energy of a laser beam and the substrate table feeding rate. The coefficient a for f(x) corresponding to the mask is therefore found empirically in advance. In a case where g(x), h(x), and so on corresponding to other masks are used, coefficients b, c, and so on similar to the coefficient a and corresponding to these g(x), h(x), and so on are also found empirically in advance. It thus becomes possible to process a shape corresponding to a multidimensional polynomial including many coefficients expressed by an equation (4) below.

The equation (4) is expressed as:

G(x)=af(x)+bg(x)+ch(x).

Consequently, it becomes possible to obtain a processing shape expressed by an infinite multidimensional polynomial using masks for f(x), g(x), and h(x) corresponding to finite multidimensional monomials. This ability is the most significant characteristic of the embodiment of the present invention.

### First Example of Mask Configuration

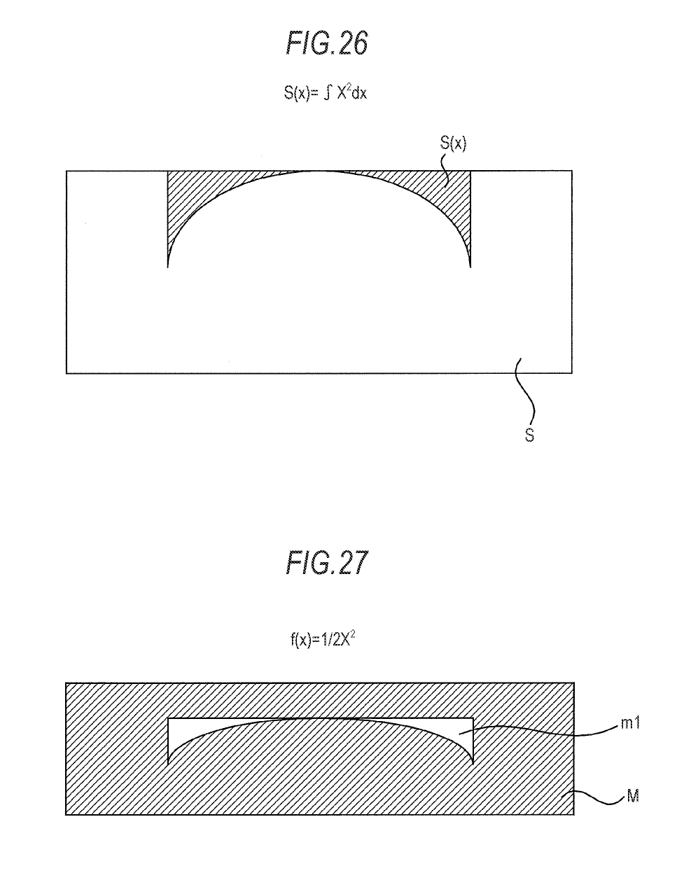

A first example of the mask configuration is a case where a convex shape is processed with a function expressed by an equation (5): F(x)=X². In this case, a sectional area S(x) processed by the laser processing (etching) from the substrate surface is a portion indicated by hatching in FIG. 26. The sectional area S(x) is expressed by an equation (6) below.

The equation (6) is expressed as:

S(x)=∫X²dx.

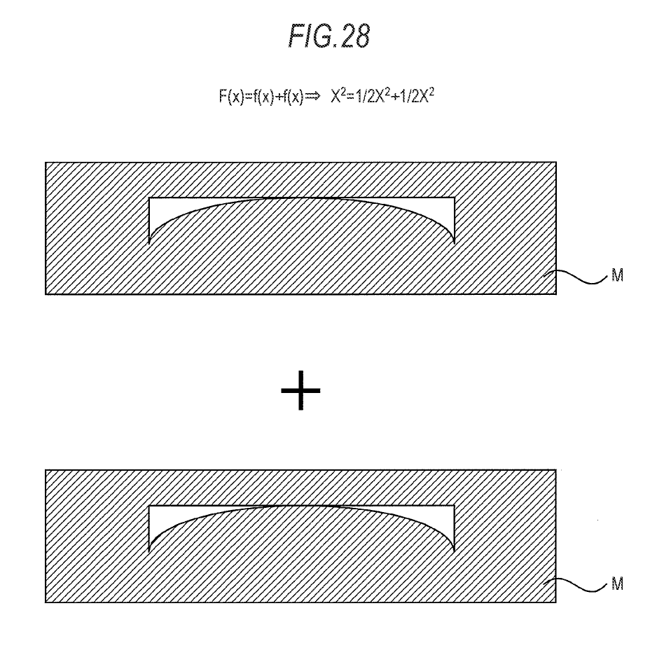

In order to obtain this processing shape, a mask M corresponding to a function f(x)=½X² shown in FIG. 27 is used and a laser beam is irradiated repetitively twice using the same mask M. Consequently, a convex processing shape expressed by F(x)=X² can be obtained. More specifically, as is shown in FIG. 28, by repetitively irradiating a laser beam twice using the mask expressed by the function f(x), the result can be expressed by an equation (7) below.

That is, the equation (7) is expressed as:

F(x)=f(x)+f(x),

which can be re-written as:

X²=½X²+½X².

This means that the processing shape expressed by the function, F(x)=X², can be achieved by irradiating a laser beam repetitively twice using the mask corresponding to f(x)=½X².

Likewise, in order to process a convex shape corresponding to the profile of an equation (8) expressed as: F(x)=2X², a laser beam is irradiated repetitively four times using the mask corresponding to f(x)=½X² above. It thus becomes possible to obtain a processing shape corresponding to F(x)=2X².

### Second Example of Mask Configuration

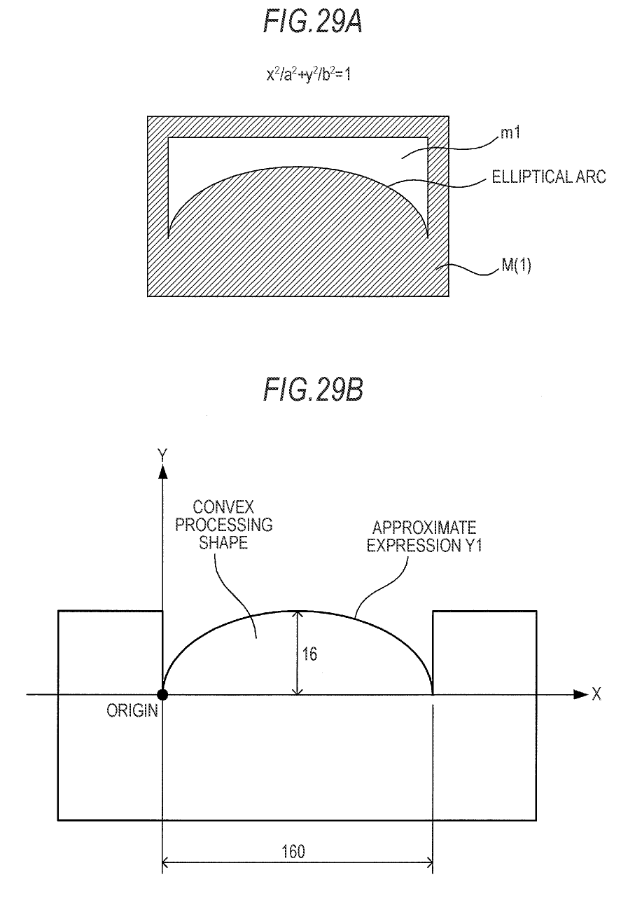

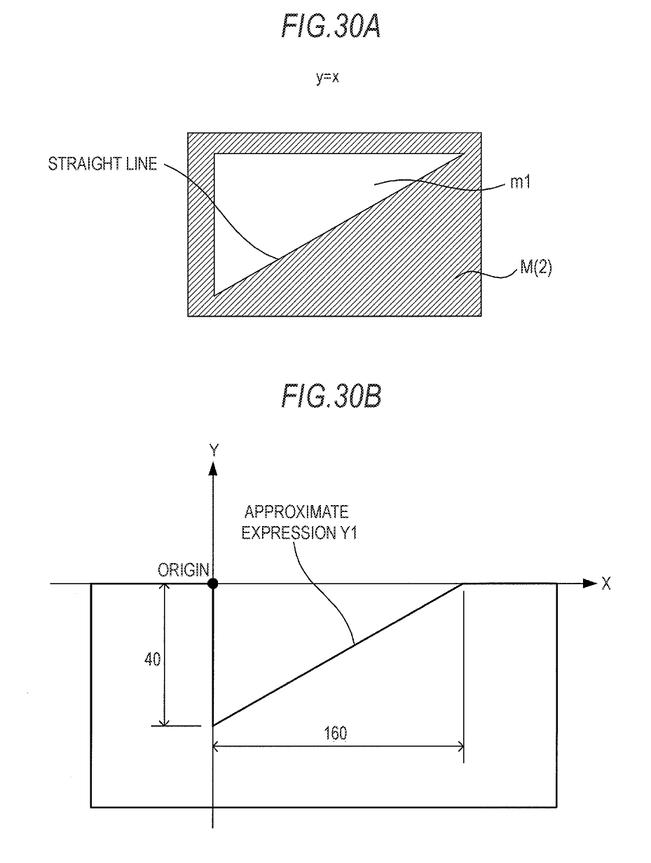

A second example of the mask configuration is a case where a mask having an elliptical arc shown in FIG. 29A and a linear mask shown in FIG. 30A are used.

Initially, a mask M(1) having an elliptical arc on the rim of an opening m1 as shown in FIG. 29A is used and energy of light and a feeding rate of the substrate as a processing object are set. A processing shape obtained as a result is measured in advance.

FIG. 29B is a view showing a graph that mathematically approximates the profile obtained from the actually processed shape using the mask M(1). Herein, the X and Y axes having the origin at the left end in the drawing at the bottom of a convex processing shape are set. The resulting concrete processing shape has a convex having a height of 16 and a bottom having a length of 160. The unit of numerical values used herein is μm.

From this graph, an equation (9) below is obtained as an approximate expression of an ellipse (when 0<x<80) and an equation (10) below is obtained as an approximate expression of an ellipse (when 80≦x<160).

The equation (9) is expressed as:

{(X−80)²/(80)²}+{(Y1+16)²/(16)²}=1.

The equation (10) is expressed as:

{(X−80)²/(80)²}+{(Y1+32)²/(32)²}=1.

Also, FIG. 30B shows a graph that mathematically approximates the profile obtained from the actually processed shape using a mask M(2) having a straight line on the rim of the opening m1 as is shown in FIG. 30A. Herein, the X and Y axes having the origin at the left end in the drawing of the processing portion on the substrate surface to be processed are set. The actual resulting processing shape is an inverted triangular shape when viewed in a cross section and has a depth of 40 and a width of 160. The unit of numerical values used herein is μm. An approximate expression obtained from this graph is an equation (11) below.

The equation (11) is expressed as:

Y2=(X/4)−40.

Hence, from the equation (9) and the equation (11) above, an equation (12) below is found when 0≦x<80 and an equation (13) below is found when 80≦x<160. Hence, an actual etching amount is found in accordance with an equation (14) below.

The equation (12) is expressed as:

Y1={⅕√(6400−(X−80)²}−16.

The equation (13) is expressed as:

Y1={⅖√(6400−(X−80)²}−32.

The equation (14) is expressed as:

Y=Y1+Y2.

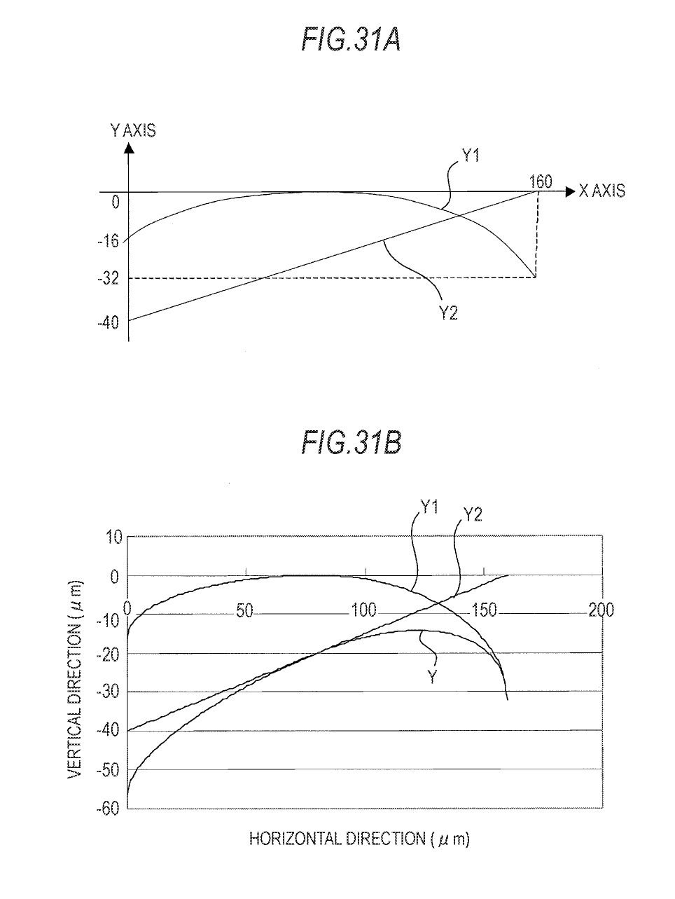

Hence, by irradiating a laser beam repetitively using the mask M(1) having the elliptical arc shown in FIG. 29A and the linear mask M(2) shown in FIG. 30A, it becomes possible to obtain a fused profile shown in FIG. 31A and FIG. 31B as the processing shape.

FIG. 31A shows Y1 corresponding to the mathematically approximated equations (12) and (13) above and Y2 corresponding to the equation (11) above. Also, FIG. 31B shows the actually obtained shape and shows Y1 and Y2 and an etching amount Y actually obtained when a laser beam is repetitively irradiated.

According to the mask configurations as above, even with a mask used to obtain a processing shape having a complex profile, it becomes possible to save the time necessary for the mask settings and the manufacturing costs. Also, even with a mask given by a small number of multidimensional monomials, it becomes possible to obtain a processing shape having a profile corresponding to various multidimensional polynomials by suitably combining such masks.

In a processing device provided with a debris (processing waste) collection mechanism, a collection amount at a time is limited. According to the embodiment of the present invention, however, because processing is performed by dividing into a plurality of operations by combining masks given by multidimensional monomials, debris collection efficiency can be enhanced.

Also, by managing an aspect ratio of the mask pattern and an aspect ratio of the processing shape in the form of multiple numbers, it becomes possible to exactly transfer a 2D mask to a 3D processing shape independently of the aperture of the mask or the like.

Also, because it is not necessary to design a multidimensional polynomial curve by the CAD, conversion software is unnecessary. Further, it is possible to avoid an error in conversion. Furthermore, a boundary line between a laser beam transmitting portion and a laser beam non-transmitting portion in the mask is transferred by the laser processing as a large amount of irradiation traces on the processed surface when the substrate is moved. However, according to the embodiment of the present invention, because a laser beam is irradiated by dividing into a plurality of operations, it becomes possible to obtain a smooth shape having fewer irradiation traces.

### 9. Applicable Field

An embodiment of the present invention is applicable to a laser processing device and a laser processing method for processing a pattern on a transparent conducting film used as a transparent electrode on a multi-layer thin film in an FPD (Flat Panel Display) and a solar cell, a resin film, and a metal thin film. In particular, the embodiment of the present invention can be adopted suitably to means for applying 3D processing to a processing object according to a mask shape by irradiating a laser beam from the top surface of the processing object via a mask.

The present application contains subject matter related to that disclosed in Japanese Priority Patent Application JP 2009-053083 filed in the Japan Patent Office on Mar. 6, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. An optical processing method comprising the steps of:
moving an irradiation region of light in a direction orthogonal to a width direction of a mask having a plurality of openings aligned in the width direction while irradiating the light to a processing object via the mask; and
when irradiating light across one width of the mask and moving the irradiation region in a latter stage after irradiation of light across one width of the mask and movement of the irradiation region in a former stage end, superimposing a part of a light irradiation portion by the irradiation of light across one width of the mask and the movement of the irradiation region in the former stage and a part of a light irradiation portion by the irradiation of light across one width of the mask and the movement of the irradiation region in the latter stage to make an irradiation amount of light equal in each of irradiation lines corresponding to the respective openings.

2. The optical processing method according to claim 1,
wherein a plurality of the openings in line along the width direction of the mask are provided in a plurality of lines in the direction orthogonal to the width direction and the number of the plurality of the openings corresponding to the parts to be superimposed varies line by line.

3. The optical processing method according to claim 1,
wherein a plurality of the openings in line along the width direction of the mask are provided in a plurality of lines in the direction orthogonal to the width direction and the number of the plurality of the openings corresponding to the parts to be superimposed gradually varies line by line.

4. The optical processing method according to claim 1,
wherein a plurality of the openings in line along the width direction of the mask are provided in a plurality of lines in the direction orthogonal to the width direction and the number of the plurality of the openings corresponding to the parts to be superimposed varies in a part of the lines.

5. The optical processing method according to claim 1,
wherein the movement of the irradiation of light is performed in mutually orthogonal two directions on the processing object.

6. The optical processing method according to claim 1,
wherein a first mask and a second mask having different shapes and a same pitch of the plurality of openings are used as the mask and the irradiation of light and the movement of the irradiation region are performed at a same position on the processing object using the first mask and the second mask.

7. The optical processing method according to claim 6,
wherein a shape of a rim of each opening in the first mask is formed of a curve and a shape of a rim of each opening in the second mask is formed of a straight line.

8. A mask comprising:
an opening forming region in which a plurality of openings are aligned vertically and horizontally;
a first region including a diagonal line at a predetermined angle with respect to a central axis of the opening forming region in a horizontal direction in a predetermined region on one side of the central axis; and
a second region including a diagonal line at a same angle as the predetermined angle with respect to the central axis in a predetermined region on the other side of the central axis.

9. A mask comprising:
an opening forming region in which a plurality of openings are aligned vertically and horizontally;
a first region including a diagonal line at a predetermined angle with respect to a central axis of the opening forming region in a horizontal direction in a predetermined region on one side of the central axis; and
a second region line symmetric to the first region with respect to the central axis in a predetermined region on the other side of the central axis.
